(19) United States
(12) Patent Application Publication
(10) Pub. No.: US 2007/0099520 A1
(43) Pub. Date: May 3, 2007

(54) Connecting terminal

(76) Inventors: Tsugio Anbo, Tokyo (JP); Yukifumi Machida, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/560,788

(22) PCT Filed: Jun. 17, 2004
(86) PCT No.: PCT/JP04/08537

§ 371 Date: Nov. 21, 2006

(30) Foreign Application Priority Data
Jun. 18, 2003 (JP) 2003-173929

(51) Int. Cl. H01R 13/11

(52) U.S. Cl. 439/852

(57) ABSTRACT

A connecting terminal has a rectangular tube-like connecting portion 11 including a bottom plate 13, a first side plate not shown, a top plate 15 and a second side plate 16. At a rear end of the top plate 15, there is formed a locking portion 19 by folding a rear end of the top plate inwardly. A stabilizer portion 17 provided at one side of the second side plate 16 is bent downwardly into a semicircular shape to extend downwardly with respect to the bottom plate.

### TECHNICAL FIELD

The present invention relates to a female type connecting terminal for receiving a male type connecting terminal, said female type and male type connecting terminal constituting an electrical connector.

### TECHNICAL BACKGROUND

A female type connecting terminal of the kind mentioned above is provided within a housing and is used to establish the electrical connection by receiving a cooperating male type connecting terminal. When the male type connecting terminal is inserted into the female type connecting terminal, the female type connecting terminal is pushed backwardly. In order to prevent the female type connecting terminal from being removed out of the housing, a connecting portion of the connecting terminal is engaged with a resilient locking lance provided in the housing.

In order to keep the connecting terminal 1 within the housing, a stabilizer portion 3 extending in a longitudinal direction is provided on an upper wall of a connecting portion 2 as illustrated in FIG. 7, said stabilizer portion 3 serving to prevent a swinging motion of the connecting terminal 1 within the housing. The stabilizer portion 3 also serves to prevent an erroneous insertion of the connecting terminal 1 into the housing, and the connecting terminal could not be inserted in an up side down fashion.

### DISCLOSURE OF THE INVENTION

Problems to be Solved by the Invention

Recently electrical connectors having small size and a large number of connecting terminals have been required, and accordingly connecting terminals installed within housings have been also required to have small size. In order to insert the connecting terminal 1 into the housing through a locking lance, a width of the locking lancer has to be a width of the connecting portion 2 reduced by a width of the stabilizer portion 3. Therefore, a width of the locking lancer should be very small and could not generate a sufficiently large force for locking the connecting terminal.

The present invention has for its object to provide a connecting terminal, which can remove the above mentioned problems and a width of the locking lance is not effected by the stabilizer portion.

Means for Solving the Problems

According to the invention, a connecting terminal including a connecting portion formed in a rectangular tube having a top plate to which a locking lancer provided in a housing is to be engaged, characterized in that a stabilizer portion for stabilizing a posture of the connecting terminal within the housing is provided on a bottom plate of said connecting portion to extend in a longitudinal direction.

Merits of the Invention

In the connecting terminal according to the invention, since the stabilizer portion is provided on the bottom wall of the connecting portion, a width of the locking lance provided on the housing for preventing a withdrawal of the connecting terminal backwardly can be set to be substantially identical with a width of the connecting portion without considering a width of the stabilizer portion, and therefore the connecting terminal can be prevented effectively with a rather large force from being removed from the housing.

### BRIEF DESCRIPTION OF THE DRAWINGS

FIG. 1 is a plan view showing an embodiment of the connecting terminal according to the invention.

FIG. 2 is a front view of the connecting terminal.

FIG. 3 is a side view of the connecting terminal.

FIG. 4 is a cross sectional view of the connecting terminal.

FIG. 5 is an exploded view showing the connecting terminal before assembling.

FIG. 6 is a cross sectional view illustrating the connecting terminal installed within the housing.

FIG. 7 is a perspective view showing a known connecting terminal.

### EXPLANATION OF REFERENCE NUMERALS

11 connecting portion
12 wire clamping portion
13 bottom plate
14, 16 side plate
15 top plate
17 stabilizer portion
19 locking portion
21 movable contact strip
32 housing
33 locking lance
   Best Mode of the Invention

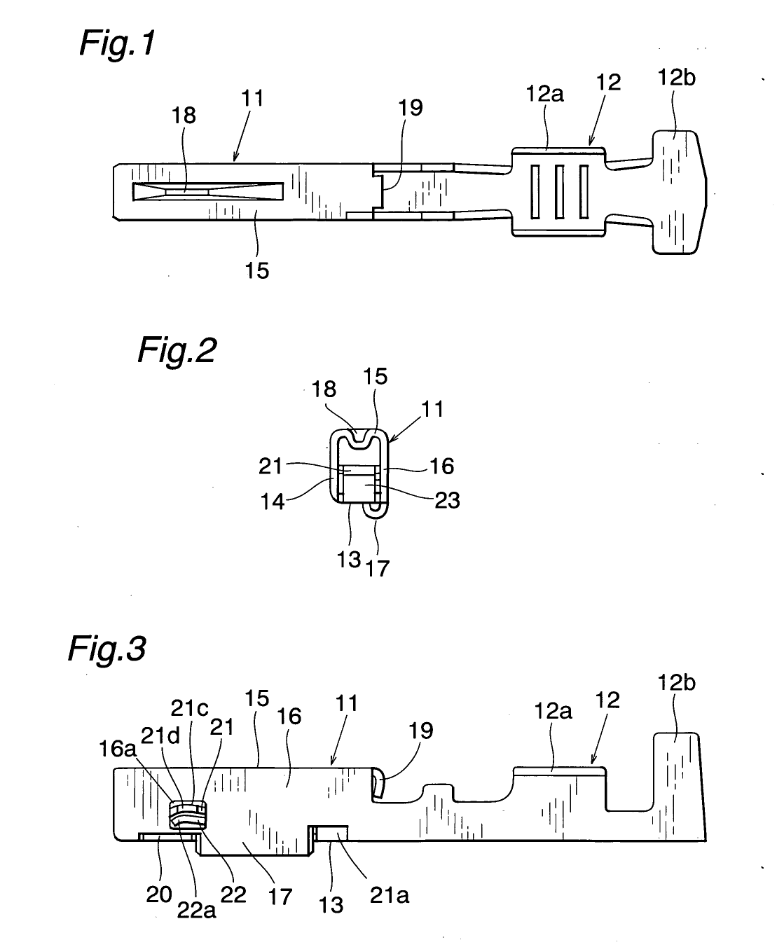

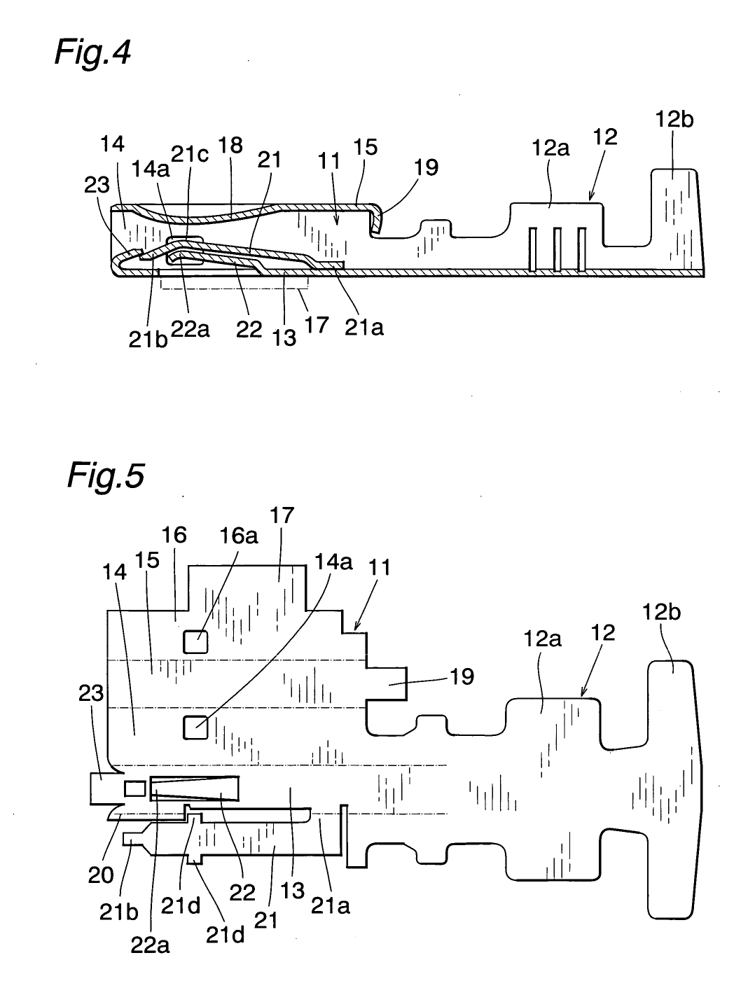

FIG. 1 is a plan view, FIG. 2 is a front view, FIG. 3 is a side view, FIG. 4 is a cross sectional view, and FIG. 5 is exploded plan view before assembling showing an embodiment of connecting terminal according to the invention. The connecting terminal is formed by punching a single metal plate into a given shape, and then folding and bending various portions. Generally speaking, the connecting terminal comprises a rectangular tube-like connecting portion 11 provided at a front side and a wire clamping portion 12 provided at a rear side. As usual, the wire clamping portion 12 includes a core conductor clamping portion 12a and a sheath clamping portion 12b, these clamping portions being formed into a U-shape.

The connecting portion 11 comprises a bottom plate 13, a first side plate 14 connected to one side of the bottom plate, a top plate 15, a second side plate 16 and a stabilizer portion 17, which are successively coupled with each other in this order. The bottom plate 13, first sided plate 14, top plate 15 and second side plate 16 are folded to constitute a rectangular tube. In the top plate 15 there is formed a recessed portion 18 which extends in a longitudinal direction and is bend inwardly. At a rear end of the top plate 15 there is further formed a locking portion 19, which is bent inwardly to be engaged with a locking lance provided on a housing.

The stabilizer portion 17 formed at a side of the second side plate 16 is bent to have a semicircular cross section in such a manner that the stabilizer portion 17 protrudes downward from the bottom plate 13 at a side of the second side plate 16 and a free end of the stabilizer portion 17 is brought into contact with the lower surface of the bottom plate 13. That is to say, the stabilizer portion 17 is provided on the one side of the bottom plate 13 eccentrically to prevent the bottom plate 13 from being pushed downward. There is further provided a closing portion 20 for closing the connecting portion 11.

On the other side of the bottom plate 13 there is formed a movable contact strip 21 to extend in parallel with the bottom plate 13. The movable contact strip 21 is secured to the rear portion of the bottom plate 13 at a base portion 21a. Prior to the formation of the connecting portion 11, the movable contact strip 21 is folded at the base portion 21a over the bottom plate 13 and is bent in such a manner that a portion of the movable contact strip 21 between the base portion 21a and a free front end 21b is bent upward into a shape of mountain. On both sides of the movable contact strip 21 there are formed wing portions 21d. These wing portions 21d are inserted movably into holes 14a and 16a formed in the first and second side plates 14 and 16, respectively upon constructing the connecting portion 11.

In the bottom plate 13 there is further formed an elongated reinforcing strip 21 by cutting such that a rear end of the reinforcing strip 22 is connected to the bottom plate 13. The reinforcing strip 22 is folded inwardly such that a front end 22a is brought into contact with a lower surface of a contact portion 21c of the movable contact strip 21.

At the front end of the connecting portion 11, there is provided a guide strip 23, which is formed by folding a front portion of the bottom plate 13 inwardly. The guide strip 23 covers the free front end 21b of the movable contact strip 21 to prevent a forward movement of the free front end and to guide the insertion of the corresponding male type connecting terminal.

In the connecting terminal according to the invention having the above explained structure, the contact portion 21c of the movable contact strip 21 can be provided at a relatively front position within the connecting portion 11, and furthermore since the free end 21b of the movable contact strip 21 is constructed by the front end, a resilient force of the movable contact strip 21 is relatively small and a necessary force for inserting the corresponding male type connecting terminal can be reduced.

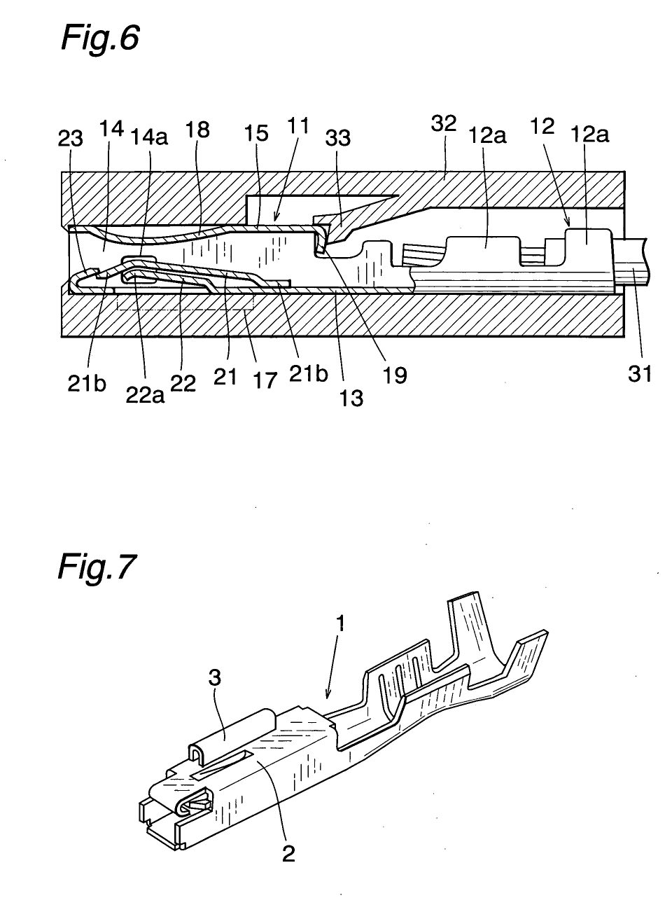

FIG. 6 is a cross sectional view showing a condition in which an electrical wire 31 is connected to the wire clamping portion 12 and the connecting terminal is inserted into the housing 32. The stabilizer portion 17 is clamped into a recess formed in the housing 32, and therefore a posture of the connecting terminal within the housing 32 can be stabilized. Furthermore, an erroneous insertion of the connecting terminal can be effectively prevented, because the connecting terminal could not be inserted in an up side down fashion.

When the connecting portion 11 is inserted into the housing 32, the resilient locking lance 33 is pushed upward and the connecting portion 11 passes under the locking lance 33. In this case, since the stabilizer portion 17 is formed under the connecting terminal, a width of the locking lance 33 can be determined without considering the stabilizer portion 17 and can be set to a large value substantially equal to a width of the connecting portion 11. Therefore, a large locking force due to the engagement of the locking lance 33 with the locking portion 19 can be attained.

1. A connecting terminal including a connecting portion formed in a rectangular tube having a top plate to which a locking lancer provided in a housing is to be engaged, wherein a stabilizer portion for stabilizing a posture of the connecting terminal within the housing is provided on a bottom plate of said connecting portion to extend in a longitudinal direction.

2. The connecting terminal according to claim 1, wherein said connecting terminal is formed by punching, bending and folding a single metal plate.

3. The connecting terminal according to claim 1, wherein said stabilizer is formed on the bottom plate eccentrically.

4. The connecting terminal according to claim 1, wherein said connecting portion of the connecting terminal is formed in a shape of a rectangular tube surrounded by the bottom plate, a first side plate connected to one side of the bottom plate, a top plate connected to the first side plate, a second side plate connected to the top plate, and the stabilizer portion connected to the second side plate.

5. The connecting terminal according to claim 1, wherein said stabilizer portion is curved downwardly in a semicircular shape and a free end of the stabilizer portion is brought into contact with the bottom plate.

6. The connecting terminal according to claim 1, wherein said connecting portion includes resilient contact strips formed within the connecting portion, and each of said movable contact strips is formed by a part of the connecting portion from a rear side toward a front side.

7. The connecting terminal according to claim 2, wherein said connecting portion of the connecting terminal is formed in a shape of a rectangular tube surrounded by the bottom plate, a first side plate connected to one side of the bottom plate, a top plate connected to the first side plate, a second side plate connected to the top plate, and the stabilizer portion connected to the second side plate.

8. The connecting terminal according to claim 3, wherein said connecting portion of the connecting terminal is formed in a shape of a rectangular tube surrounded by the bottom plate, a first side plate connected to one side of the bottom plate, a top plate connected to the first side plate, a second side plate connected to the top plate, and the stabilizer portion connected to the second side plate.

9. The connecting terminal according to claim 2, wherein said stabilizer portion is curved downwardly in a semicircular shape and a free end of the stabilizer portion is brought into contact with the bottom plate.

10. The connecting terminal according to claim 3, wherein said stabilizer portion is curved downwardly in a semicircular shape and a free end of the stabilizer portion is brought into contact with the bottom plate.

11. The connecting terminal according to claim 4, wherein said stabilizer portion is curved downwardly in a semicircular shape and a free end of the stabilizer portion is brought into contact with the bottom plate.

12. The connecting terminal according to claim 7, wherein said stabilizer portion is curved downwardly in a semicircular shape and a free end of the stabilizer portion is brought into contact with the bottom plate.

13. The connecting terminal according to claim 8, wherein said stabilizer portion is curved downwardly in a semicircular shape and a free end of the stabilizer portion is brought into contact with the bottom plate.
